(19) United States
(12) Patent Application Publication
(10) Pub. No.: US 2022/0168734 A1
(43) Pub. Date: Jun. 2, 2022

(54) MICROFLUIDIC APPARATUS AND METHOD

(71) Applicant: QuantuMDx Group Limited, Newcastle upon Tyne, Tyne and Wear (GB)

(72) Inventors: Thomas Michael WILLSHARE, Newcastle upon Tyne, Tyne and Wear (GB); Hojjat MADADI, Newcastle upon Tyne, Tyne and Wear (GB); James BENNETT, Newcastle upon Tyne, Tyne and Wear (GB); Philip SCULLY, Newcastle upon Tyne, Tyne and Wear (GB)

(21) Appl. No.: 17/298,252

(22) PCT Filed: Nov. 28, 2019
(86) PCT No.: PCT/GB2019/053361

§ 371 Date: May 28, 2021

(30) Foreign Application Priority Data
Nov. 29, 2018 (GB) 1819415.9

(51) Int. Cl. B01L 3/00; B01L 7/00

(52) U.S. Cl. CPC B01L 3/502715; B01L 7/52; B01L 2200/04; B01L 2300/087; B01L 2200/16; B01L 2300/0877; B01L 2200/0689

(57) ABSTRACT

A microfluidic cassette has a microfluidic cassette body having at least one fluid flow channel and at least one chamber containing reagent. The chamber has a seal to prevent fluid from entering the chamber. The seal is breakable in situ in the cassette body. The cassette body and the chamber are configured such that when the seal is broken, the reagent is exposed to fluid flow in the channel.

### PRIORITY AND CROSS REFERENCE TO RELATED APPLICATIONS

This application is the U.S. National Phase Application under 35 U.S.C. § 371 of International Application No. PCT/GB2019/053361, filed Nov. 28, 2019, designating the U.S. and published in English as WO 2020/109797 A1 on Jun. 4, 2020, which claims the benefit of Great Britain Application No. GB 1819415.9, filed Nov. 29, 2018. Any and all applications for which a foreign or a domestic priority is claimed is/are identified in the Application Data Sheet filed herewith and is/are hereby incorporated by reference in their entireties under 37 C.F.R. § 1.57.

### TECHNICAL FIELD

The present invention relates to microfluidic devices and more particularly to microfluidic cassettes used with such devices.

### BACKGROUND

Microfluidic diagnostic devices can provide rapid point of care diagnosis of health conditions based on fluid samples provided by a patient. Such devices may comprise diagnostic electronics or other components that enable them to interact with and perform diagnostic tests on a fluid sample contained in a microfluidic cassette. A microfluidic cassette for use with such devices typically includes a plurality of fluid flow channels that enable a fluid sample to pass through the cassette and interact with various reagents contained within the cassette. The microfluidic diagnostic device can perform diagnostic tests using a fluid sample by imaging/sensing the fluid sample at different imaging/sensing locations in the cassette.

To help ensure accurate and reliable results from the microfluidic diagnostic device it is desirable for reagents used within the cassette to be maintained in a good condition and away from moisture and other contaminants. Moisture can be a problem when dried or wet reagents are used. However, moisture is a particular problem when dried (or lyophilised) reagents are used because such reagents are hydrophilic and even small amounts of moisture can interact with and potentially reduce the effectiveness of such reagents.

It is also desirable to provide a microfluidic cassette that is cost effective to manufacture, easy for a user to operate and that has a long shelf life without significant degradation of reagents.

It is known to deposit reagents directly onto a fluid flow channel of a microfluidic cassette during manufacturing of the cassette. However, in this arrangement even if the microfluidic cassette is sealed during manufacture, moisture from the atmosphere or vapour arising from fluids deliberately stored in the cassette can contact and degrade the reagent over time. This can reduce the effectiveness of diagnostic tests performed using the cassette and/or reduce the storage life of the cassette.

EP2821138A1 discloses a cassette arrangement whereby dried substance is deposited on a carrier element for introduction into an aperture in the cassette to form a wall of a fluid flow channel of the cassette. This arrangement can improve the manufacturability of cassettes. However, it suffers from similar disadvantages as discussed above regarding depositing reagent directly in fluid flow channels, namely that the dried substance is exposed inside the cassette after cup insertion and will tend to degrade over time, particularly as a result of moisture/vapour. This arrangement can also result in a “dead zone” of dried substance that is retained on the carrier element after fluid flow has occurred or can require a smaller amount of dried substance to be used to reduce this effect.

US2017/014826A1 discloses a cassette arrangement whereby dried chemicals are held in a container for introduction into an aperture in the cassette to form a wall of a fluid flow channel of the cassette. The container may include a lid or film that may be manually or automatically removed before insertion of the container into the cassette. This arrangement requires an additional user step whereby the lid or film is removed and the container is introduced into the cassette immediately before use. Further, even if the removeable lid or seal is removed automatically during insertion, dried chemicals in the container are still exposed to the local environment immediately before the container is introduced into the cassette, thereby risking degradation of the reagent. Further, prior to inserting the container into the cassette, the aperture in the cassette (and, as a result, the fluid flow channel) is exposed to moisture the local environment or otherwise requires an additional and potentially complex sealing mechanism to prevent moisture and other contaminants from entering the cassette prior to container insertion. Additionally, further steps may be required to try to recover dried chemicals retained in the container.

It is an object of certain embodiments of the present invention to provide a cassette arrangement that addresses some or all of these disadvantages.

### SUMMARY OF THE INVENTION

In accordance with a first aspect there is provided a microfluidic cassette comprising a microfluidic cassette body comprising at least one fluid flow channel, and at least one chamber containing reagent. The chamber comprises a seal to prevent fluid from entering the chamber. The seal is breakable in situ in the cassette body. The cassette body and the chamber are configured such that when the seal is broken, the reagent is exposed to fluid flow in the channel.

Optionally the microfluidic cassette further comprises a sealing layer on a surface of the cassette body adjacent to the at least one chamber to prevent fluid outside the microfluidic cassette from contacting the cassette body.

Optionally the microfluidic cassette further comprises an insert and the insert comprises the at least one chamber.

Optionally the seal is breakable in situ when a piercing force is applied to the seal.

Optionally the cassette body comprises one or more seal breaking mechanisms adapted to break the seal.

Optionally the one or more seal breaking mechanisms comprise one or more structures adapted to pierce the seal in situ in the cassette body, and the insert is secured within the cassette body and is movable from a first position within the cassette body where the seal is not in contact with the one or more structures to a second position within the cassette body where the seal is in contact with the one or more structures.

Optionally the one or more structures are adapted such that when the seal is pierced, a fluid flow channel through the chamber is formed, the fluid flow channel in fluid communication with the fluid flow channel of the cassette body.

Optionally, the one or more structures comprise a first annular wall enclosing a first fluid aperture and a second annular wall enclosing a second fluid aperture, and the first and second fluid apertures are in fluid communication with the fluid flow channel of the cassette body.

Optionally, at least one of the annular walls includes a cut-out region around part of the circumference of the wall.

Optionally, the cassette body further comprises a cover element arranged to provide a sealed chamber enclosing the one or more structures and the insert.

Optionally, the insert is secured to an inner surface of the cover element.

Optionally, the cover element is resiliently deformable.

Optionally, the cover element is arranged to hold the insert in the first position and is resiliently deformable to move the insert into the second position.

Optionally, the cassette body further comprises an outer wall enclosing the one or more structures, said outer wall shaped to guide movement of the insert between the first and second position.

Optionally the seal is breakable in situ when exposed to a temperature substantially above atmospheric temperature.

Optionally the seal is breakable in situ when exposed to a directional beam of light, and the microfluidic cassette comprises at least one pathway that allows light to pass through the cassette and contact the seal.

Optionally, the cassette further comprises at least one gasket or bead extending around the cassette body, the gasket or bead arranged to provide a fluid impermeable seal between the cassette body and the insert on contact with the insert.

In accordance with a second aspect there is provided a microfluidic diagnostic system comprising a microfluidic cassette according to the first aspect; and a microfluidic diagnostic device adapted to receive the microfluidic cassette. The device comprises one or more actuators adapted to break the seal of the microfluidic cassette.

Optionally the one or more actuators comprise an aperture shaped to receive the microfluidic cassette body.

Optionally the one or more actuators comprise a moveable actuating member.

Optionally the one or more actuators comprise a source of heat.

Optionally the one or more actuators comprise a source of directional light.

In accordance with a third aspect there is provided an insert for a microfluidic cassette body comprising: at least one chamber containing reagent, the chamber comprising a seal to prevent fluid from entering the chamber, wherein the seal is breakable in situ in the cassette body.

In accordance with a fourth aspect there is provided a method of manufacturing a microfluidic cassette comprising: providing a microfluidic cassette body comprising at least one fluid flow channel; and providing at least one chamber containing reagent, the chamber comprising a seal to prevent fluid from entering the chamber. The seal is breakable in situ in the cassette body, and the cassette body and the chamber are configured such that when the seal is broken, the reagent is exposed to fluid flow in the channel.

Also described herein is a method of manufacturing a plurality of sealed reagent containing inserts. The method comprises loading a plurality of inserts into a plurality of pre-determined positions on a carrier structure. The method further comprises filling a chamber of each insert with reagent. The method further comprises providing a seal over the chamber of each insert to seal the reagent inside the chamber.

Optionally, the carrier structure and the inserts are shaped so that the inserts can be held in the pre-determined positions on the carrier structure.

In accordance with certain embodiments of the invention, a microfluidic cassette arrangement is provided including a cassette body and a sealed reagent containing chamber which is breakable in situ in the cassette body. Certain embodiments of the invention allow reagent to be maintained in a sealed chamber and only exposed at or immediately before use, thereby allowing the reagent to be stored with reduced or no degradation due to contact with moisture or other substances. Certain embodiments of the invention provide a fully assembled cassette arrangement that has a reagent containing chamber with an intact seal. Certain embodiments of the invention allow a cassette arrangement to be assembled, transported and stored in an environment with less stringent moisture control. Certain embodiments of the invention allow normally incompatible reagents to be used in the same cassette.

In accordance with certain embodiments of the invention, a microfluidic cassette is provided with a sealing layer adjacent to the at least one chamber. Certain embodiments of the invention provide a fluid sealed cassette arrangement including a sealed reagent containing chamber. Certain embodiments of the invention provide a cassette that can be stored without degradation and brought into use without exposing reagent to the environment and while reducing the number of steps performed by a user because the chamber seal can be broken automatically.

In accordance with certain embodiments of the invention, an insert comprising the chamber is provided. Certain embodiments of the invention provide a reagent containing chamber that can be easily and conveniently manufactured.

In accordance with certain embodiments of the invention, a seal is provided that is breakable in situ when a piercing force is applied thereto. Certain embodiments of the invention can provide a reliable and simple means to actuate a seal in situ, for example by mechanical means.

In accordance with certain embodiments of the invention, a seal breaking mechanism is provided as part of the cassette body. Certain embodiments of the invention can provide a sealed self-contained cassette unit which includes an integral seal breaking mechanism.

In accordance with certain embodiments of the invention, one or more structures adapted to pierce the seal in situ in the cassette body are provided. Certain embodiments of the invention can provide a simple and reliable mechanical seal breaking mechanism. Certain embodiments of the invention can provide a seal breaking mechanism that can be actuated when a mechanical force is applied to the cassette body without damaging the integrity of the cassette. Certain embodiments of the invention can provide a seal that is breakable when subject to a small amount of mechanical force.

In accordance with certain embodiments of the invention, the one or more structures can provide a fluid flow channel through the chamber. Certain embodiments of the invention can provide improved fluid flow characteristics through a reagent containing chamber by directing fluid through the chamber. This can allow the removal of all or a substantial amount of reagent from the chamber. Certain embodiments of the invention can result in a smaller “dead zone” (i.e. volume) of reagent being retained in the chamber after fluid flow has occurred.

In accordance with certain embodiments of the invention, a seal is provided that is breakable in situ when exposed to a temperature substantially above atmospheric temperature. Certain embodiments of the invention can provide a simple and convenient means to actuate the seal. Actuation can be affected without physical contact with the cassette and without degrading the reagent.

In accordance with certain embodiments of the invention, a seal is provided that is breakable in situ when exposed to a directional beam of light, and the microfluidic cassette includes at least one pathway that allows light to pass through the cassette and contact the seal. Certain embodiments of the invention can provide a simple and convenient means to actuate the seal. Actuation can be affected without physical contact with the cassette and with improved precision.

In accordance with certain embodiments of the invention, a microfluidic diagnostic system is provided comprising a microfluidic cassette and a microfluidic diagnostic device comprising at least one actuator adapted to break the seal of the chamber of the microfluidic cassette. Certain embodiments of the invention provide a system that requires fewer user steps to bring the cassette into operation. Embodiments of the system provide an automated means for actuating the seal.

In accordance with certain embodiments of the invention, the at least one actuator comprises an aperture shaped to receive the microfluidic cassette body. Certain embodiments can provide an arrangement whereby the cassette body is passed through an aperture and the shape of the aperture contacting the cassette body causes the seal to be actuated. Certain embodiments of the invention provide a simple mechanical means of actuating the seal.

In accordance with certain embodiments of the invention, the at least one actuator comprises a moveable actuating member. Certain embodiments of the invention provide a controllable mechanical member that can be used to actuate the seal in situ. Certain embodiments of the invention provide a precise and controllable means of seal actuation that can be fully automated.

In accordance with certain embodiments of the invention, the at least one actuator comprises a source of heat or a source of directional light. Certain embodiments of the invention provide a controllable and automated means of actuating the seal that may not require physical contact with the cassette to actuate the seal.

In accordance with certain embodiments of the invention, a reagent containing insert for a microfluidic cassette body is provided. Certain embodiments of the invention provide an insert including a seal which is breakable in situ in the cassette body. Certain embodiments of the invention provide an insert that may be easy and quick to manufacture and can be sealed at the time of manufacture to prevent fluid or other external materials from contacting and potentially degrading the reagent. Certain embodiments of the invention provide an insert that can be sealed within a cassette until a time of use.

In accordance with certain embodiments of the invention, a method of manufacturing a microfluidic cassette is provided. Certain embodiments of the invention provide a simple, quick and cost-effective method of manufacturing an improved microfluidic cassette.

Various further features and aspects of the invention are defined in the claims.

### BRIEF DESCRIPTION OF THE DRAWINGS

Embodiments of the present invention will now be described by way of example only with reference to the accompanying drawings where like parts are provided with corresponding reference numerals and in which:

FIG. 1 provides a schematic diagram of a microfluidic diagnostic system in accordance with certain embodiments of the invention;

FIG. 2 provides a schematic diagram of a microfluidic cassette arrangement before and after a seal of the cassette chamber is broken in accordance with certain embodiments of the invention;

FIG. 3 provides a further schematic diagram of a microfluidic cassette arrangement in accordance with certain embodiments of the invention;

FIG. 4 provides a schematic flow diagram of a method in accordance with certain embodiments of the invention;

FIG. 5 provides a diagram showing a cross sectional view of an insert according to an embodiment of the invention;

FIG. 6a provides a diagram showing a cross sectional view of a portion of a microfluidic cassette body according to an embodiment of the invention;

FIG. 6b shows a top view of the microfluidic cassette body of FIG. 6a;

FIG. 7 is a diagram showing a portion of a microfluidic cassette body according to an embodiment of the invention;

FIG. 8 is a diagram showing a cover element in accordance with an embodiment of the invention;

FIG. 9 is a diagram showing a cross sectional view of an assembled cassette insert arrangement according to an embodiment of the invention;

FIGS. 10a to 10d show the cassette insert arrangement of FIG. 9 in use;

FIG. 11 provides a simplified drawing showing a fluid flow passageway through a cassette insert arrangement;

FIGS. 12a to 12d show a method of manufacturing a plurality of sealed inserts; and

FIGS. 12e to 12h show a method of providing a cassette insert arrangement on a microfluidic cassette.

### DETAILED DESCRIPTION

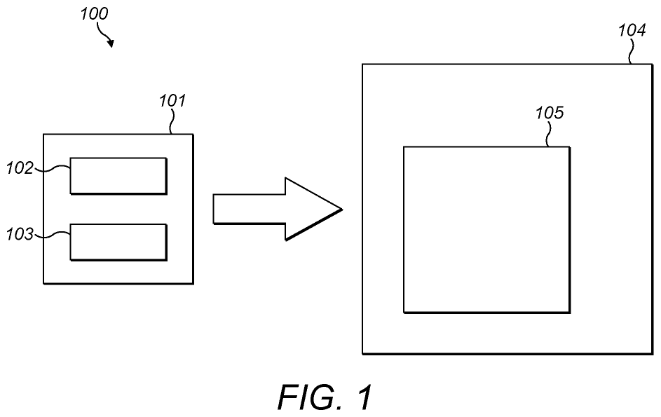

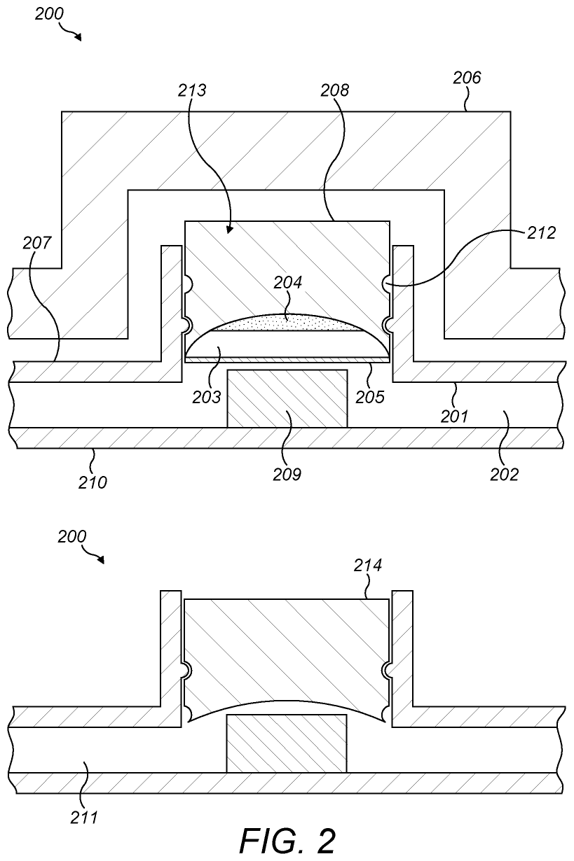

FIG. 1 provides a simplified schematic representation of a microfluidic diagnostic system 100 in accordance with certain embodiments of the invention. The system 100 comprises a microfluidic cassette 101 comprising a microfluidic cassette body 102 and at least one chamber 103. The cassette 101 may substantially correspond to the cassette described in more detail herein and in particular with reference to FIG. 2.

The system 100 further comprises a microfluidic diagnostic device 104 adapted to receive the cassette 101. The diagnostic device 104 may comprise a cassette receiving region that allows the cassette 101 to be inserted into and interact with the diagnostic device 104. The diagnostic device 104 may further comprise components that enable it to interact with the cassette 101 and perform diagnostic tests on a fluid sample contained in the cassette. For example, the diagnostic device 104 may comprise one or more diagnostic sensing and/or imaging components for conducting diagnostic sensing and/or imaging on the fluid sample (not shown). The diagnostic device 104 may also comprise components for heating and/or cooling the fluid sample.

The diagnostic device comprises one or more actuators 105. The one or more actuators 105 are adapted to break a seal of a chamber of the cassette 101 in situ as described in more detail below.

In use the cassette 101 is inserted into the diagnostic device 104 (denoted by large arrow). After the cassette 101 has been inserted into the diagnostic device 104 the seal of the chamber 103 is broken in situ via the one or more actuators 105. A fluid sample is then introduced into a fluid flow channel of the cassette 101 and diagnostic testing is performed on the sample.

The one or more actuators 105 may comprise an aperture shaped to receive the cassette body 102. That is, the one or more actuators 105 may comprise an aperture shaped to correspond to an outer shape of the cassette body 102. The shape of the aperture is such that that when the cassette body 102 is passed through the aperture, there is a small or negligible amount of clearance around the cassette body 102. Consequently, when the cassette body 102 passes through the aperture, structures extending out from the cassette body 102 will contact the edges of the aperture. As described in more detail below, in certain embodiments this contact can be used to interact with other components of the cassette body 102 to break the seal 103 of the chamber in situ.

Alternatively or additionally, the one or more actuators 105 may comprise a moveable actuating member. The moveable actuating member may move from a position where it is not in contact with the microfluidic cassette 101 into a position where it is in contact with the microfluidic cassette 101. The moveable actuating member may, after the cassette 101 has been inserted into the diagnostic device 104, apply a force to part of the cassette 101 to break the seal 103 of the chamber in situ.

Alternatively or additionally, the one or more actuators 105 may comprise a source of heat such as a heating element. The one or more actuators may apply heat to the cassette 101 or a region thereof to cause the seal of the chamber 103 to be broken in situ. As described in more detail below, in this embodiment the seal 103 of the chamber may be composed of or include a material that degrades when heat is applied.

Alternatively or additionally, the one or more actuators 105 may comprise a source of directional light such as a laser. The one or more actuators 105 may apply directional light to the seal 103 of the chamber to break the seal in situ. As described in more detail below, in this embodiment the seal 103 of the chamber may be composed of or include a material that degrades when subjected to directional light.

FIG. 2 is a schematic representation showing the same microfluidic cassette 200 in two different configurations. The cassette 200 comprises a cassette body 201. The cassette body 201 comprises at least one fluid flow channel 202. The fluid flow channel 202 enables a fluid sample to pass through the cassette. The fluid flow channel 202 is bounded by fluid flow channel walls. In the example shown in FIG. 2, the cassette further comprises an overlying film layer 210, the cassette body 201 comprises recessed regions, and the fluid flow channel walls comprise the recessed regions and the film layer 210.

The cassette 200 further comprises at least one chamber 203 containing reagent 204. The term reagent is used herein to refer to a substance or mixture for use in chemical analysis or other reactions. In certain embodiments the reagent 204 may be a dried or lyophilised substance. In certain embodiments the chamber 203 may further contain an inert gas such as nitrogen. This may further reduce degradation of a reagent and/or allow a more sensitive reagent to be used. The inert gas may be introduced into the chamber 203 during sealing of the chamber 203 in a nitrogen rich atmosphere.

In certain embodiments the reagent 204 may be a liquid or gas.

The chamber 203 comprises a seal 205 to prevent fluid from entering the chamber 203. The seal 205 is breakable in situ in the cassette body 201. The term in situ may be used herein to refer to while the at least one chamber is sealed within the cassette body 201.

In certain embodiments, the seal 205 is composed of a foil (for example comprising aluminium), a thermoplastic or a polypropylene (PP) foil composite material. Typically the seal 205 is secured (i.e. sealed) via heat-staking, laser welding or a suitable adhesive such as a thin adhesive. In certain embodiments, the seal 205 has a thickness of approximately 20 microns.

In certain embodiments, the seal 205 may be breakable when a piercing force is applied to the seal and/or when the seal is exposed to a temperature substantially above atmospheric temperature and/or when the seal is exposed to a directional beam of light.

The cassette body 201 and the chamber 203 are configured such that when the seal 205 is broken, reagent 204 in the chamber 203 is exposed to fluid in the fluid flow channel 202. This may be achieved by locating the chamber 203 adjacent to the fluid flow channel 202. The location of the chamber 203 relative to the fluid flow channel may force fluid in the fluid flow channel 202 to contact the reagent 204.

The cassette 200 further comprises a sealing layer 206 on a surface of the cassette body 201 adjacent to the at least one chamber 203. The sealing layer 206 may prevent fluid outside the cassette 200 from contacting the cassette body 201 and/or the fluid flow channel 202. The sealing layer 206 may also prevent fluid inside the cassette body 201 and/or the fluid flow channel 202 from leaving the cassette 200.

In the embodiment shown in FIG. 2, the cassette 200 further comprises an insert 208 for the cassette body 201 and the insert 208 comprises the at least one chamber 203. In this embodiment, the cassette body 201 comprises an aperture shaped to receive the insert 208. The aperture may include one or more protruding portions 212 arranged to cooperate with one or more corresponding recessed portions of the insert 208 to secure the insert 208 into the cassette body 201. The protruding portions and recessed portions may allow the insert to be moved towards or away from the fluid flow channel 202 between a first position 213 and a second position 214 within the cassette body 201 as illustrated by the two configurations shown in FIG. 2. It will be appreciated that other mechanisms to secure the insert 208 into the cassette body 201 and to allow the insert 208 to move relative to the cassette body 201 may be used, such as a tapered insert and corresponding tapered aperture provided in the cassette body 201.

The cassette body 201 may comprise one or more seal breaking mechanisms for breaking the seal 205. In the example shown in FIG. 2, the seal breaking mechanism comprises a structure 209 adapted to pierce the seal in situ in the cassette body. The structure comprises an elongate element extending towards the aperture. The structure 209 is configured such that it can break the seal 205 when the seal is forced into contact with the structure 209.

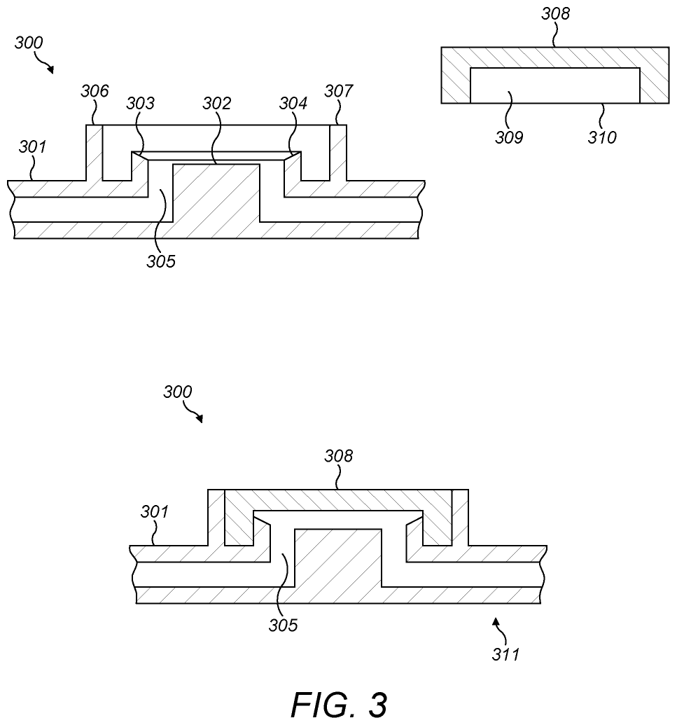

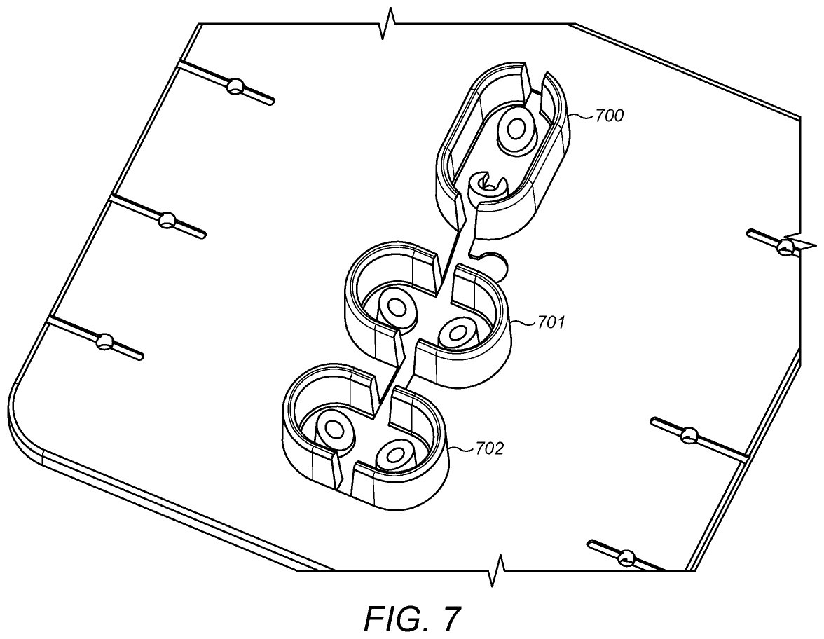

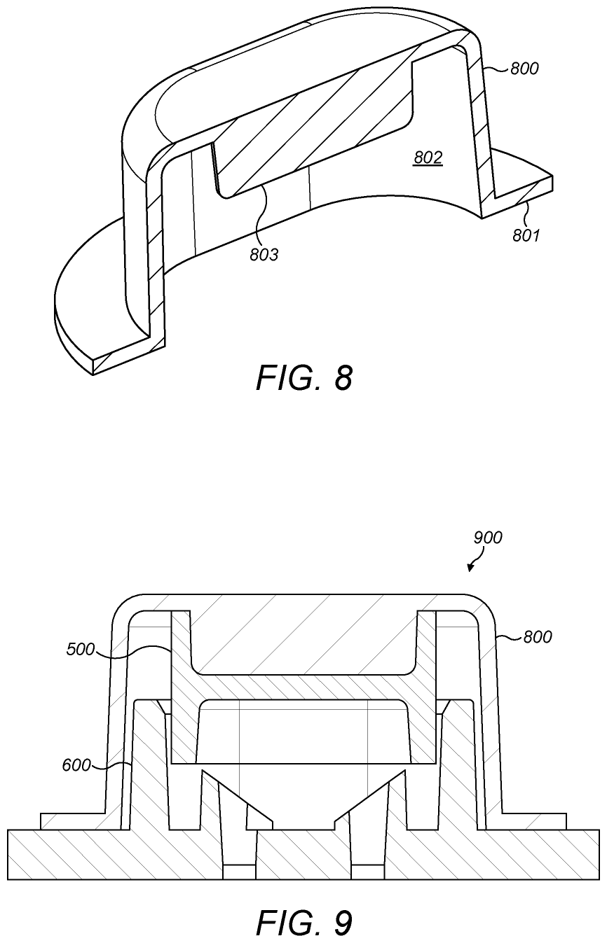

As discussed above, the insert 208 is moveable between a first position 213 and a second position 214 within the cassette body 201. In the first position 213 the chamber 203 is not in contact with the structure 209. In the second position 214 the chamber 203 is in contact with the structure 209 and the seal 205 is broken. It will be appreciated that various seal breaking structures may be provided. For example, instead of a single elongate element as shown in FIG. 2, two or more elongate elements may be provided. Examples of further seal breaking structures are described with reference to FIG. 3 and FIGS. 6a and 6b.

The one or more structures 209 are adapted such that when the seal 205 is pierced, a fluid flow channel through the chamber 203 is formed, the fluid flow channel 203 in fluid communication with the fluid flow channel 202 of the cassette body 201. This can provide a fluid flow path through the chamber 203 that results in a greater amount of reagent 204 being removed from the chamber 203.

As discussed above, in certain embodiments the seal 205 may be breakable when exposed to a temperature substantially above atmospheric temperature. In this example, the seal 205 may be composed of, include or be secured using a material having physical properties that change when heat is applied.

In certain embodiments, the seal 205 may be breakable when exposed to a directional beam of light such as a laser. In this embodiment, the cassette 200 may comprise at least one light conducting pathway that allows light to pass through the cassette 200 and contact the seal 205. The seal 205 may be composed of, include or be secured using a material having physical properties that change when directional light is applied.

FIG. 3 provides a simplified schematic diagram of a microfluidic cassette 300 in accordance with certain embodiments of the invention.

The cassette body 301 comprises a seal breaking mechanism comprising a first elongate element 302 as described with reference to FIG. 2. The seal breaking mechanism further comprises a second elongate element 303 and a third elongate element 304. The second and third elongate elements are located on either side of the first elongate element 302 and spaced apart from the first elongate element 302 such that a fluid flow channel 305 in the cassette body 301 is formed.

Typically the cassette body 301 further comprises a fourth elongate element 306 and a fifth elongate element 307 spaced apart from the second and third elongate elements to cooperate with the second and third elongate elements to hold an insert to the cassette body 301.

FIG. 3 also shows an insert 308 comprising a chamber 309 and a seal 310 as described herein.

FIG. 3 also shows the microfluidic cassette 300 in an in-use configuration 311. The insert 308 has been secured to the cassette body 301 and the seal has been broken by the seal breaking mechanism.

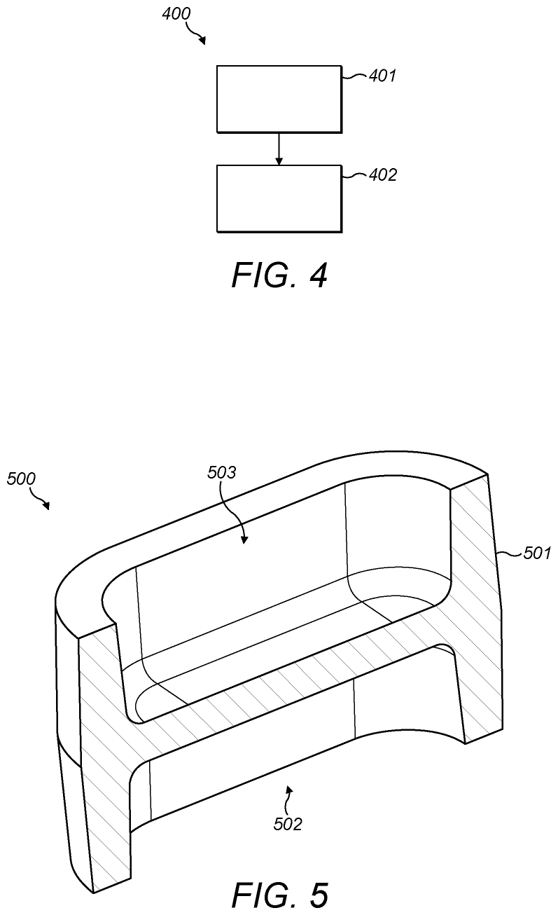

FIG. 4 provides a schematic flow diagram of a method 400 of manufacturing a microfluidic cassette in accordance with certain embodiments of the invention.

The method comprises providing 401 a microfluidic cassette body comprising at least one fluid flow channel as described herein. The method further comprises providing 402 at least one chamber containing reagent, the chamber comprising a seal to prevent fluid from entering the chamber, as described herein. The seal is breakable in situ in the cassette body. The cassette body and the chamber are configured such that when the seal is broken, the reagent is exposed to fluid flow in the channel.

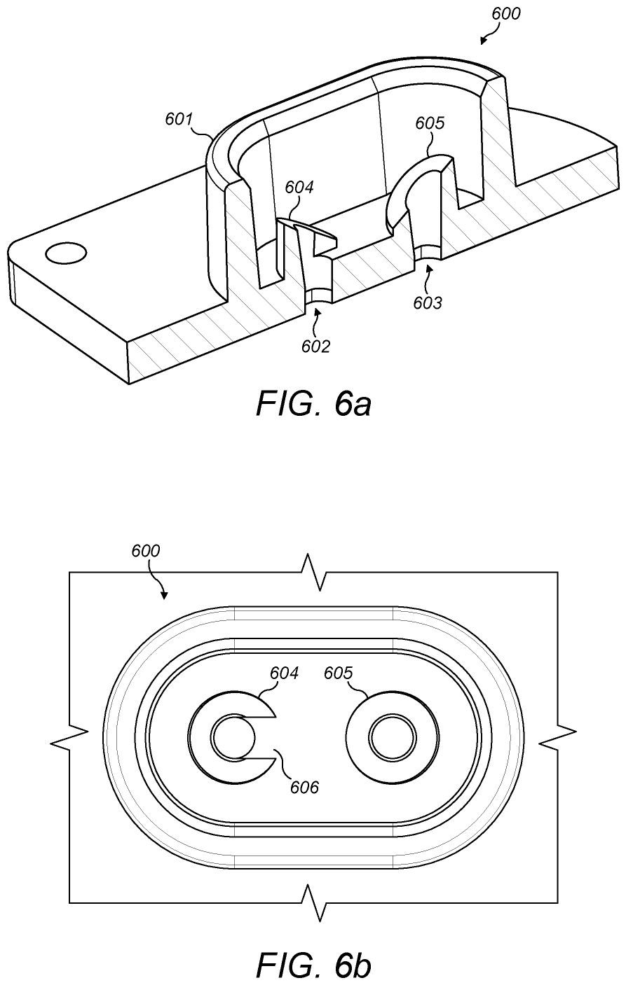

FIG. 5 provides a simplified diagram showing a cross sectional view of an insert according to an embodiment of the invention.

The insert 500 includes a body 501. The body 501 includes a first enclosed region 502. Prior to use, the first enclosed region 502 is filled with reagent and is sealed to provide a reagent containing chamber.

The body 501 also includes a second enclosed region 503. In this embodiment, the second enclosed region 503 is located opposite to and substantially corresponds in shape with the first enclosed region 502 such that the body 501 has a substantially H-shaped cross section. This makes the insert 500 symmetrical, which can improve the ease with which the insert 500 can be manufactured and filled with reagent prior to use.

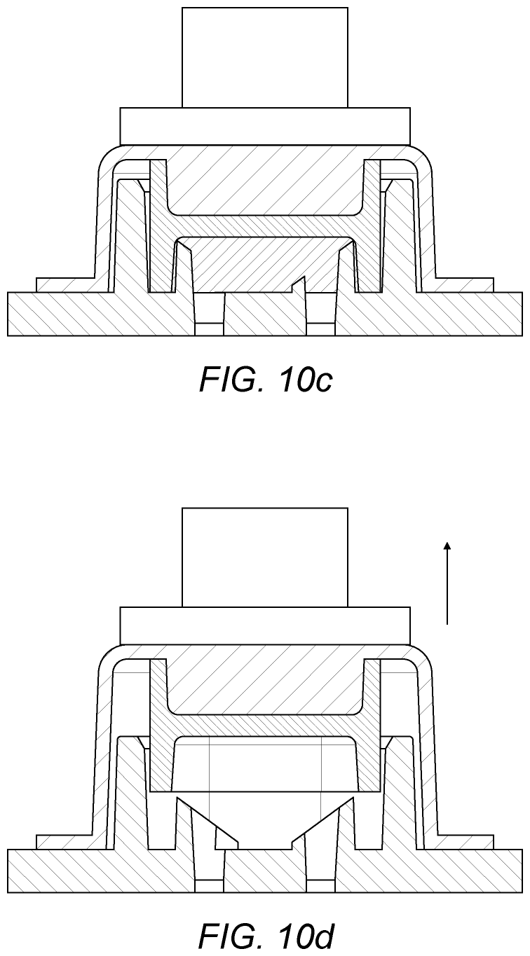

The second enclosed region 503 can be used to secure the insert 500 to another structure such as the cover 800 described with reference to FIG. 8.

FIG. 6a provides a diagram showing a cross sectional view of a portion of a microfluidic cassette body according to an embodiment of the invention. FIG. 6b shows a top view of the cassette body of FIG. 6a.

The cassette body 600 includes a surface that is arranged to overlie one or more microfluidic channels of a microfluidic cassette.

The cassette body 600 includes first and second apertures 602 603. In use, the apertures 602 603 provide fluid flow passageways with a microfluidic channel located below the cassette body 600.

The cassette body 600 also includes first and second annular walls 604 605 that extend out from the cassette body 600 and surround the first and second apertures 602 603 respectively. The first and second annular walls 604 605 provide outwardly extending protrusions which can act as seal breaking structures to pierce the seal of an insert on contact.

The cassette body 600 is arranged to provide an interface with an insert such as the insert described with reference to FIG. 5. As the insert is moved towards the annular walls 604 605, the annular walls 604 605 pierce the seal of the reagent containing chamber. Subsequently, a fluid flow passageway is formed between the chamber and a microfluidic channel via the first and second apertures 602 603.

The ends of the first and/or second annular walls 604 605 can be angled, as shown in FIG. 6a. This can improve the seal piercing ability of the annular walls 604 605 by providing a smaller point of contact with a seal.

One or both annular walls 604 605 can be provided with a section around their circumference where material has been removed to provide a cut-out region. Advantageously, providing a cut-out region can improve the fluid flow characteristics through a reagent containing chamber by encouraging mixing of fluid and reagent within the chamber. In this embodiment, the first annular wall 604 is provided with a cut-out region 606 while the second annular wall 605 is not.

The cassette body 600 also includes an outer wall 601. The outer wall 601 encloses the first and second annular walls 604 605 and acts as a guide for movement of an insert towards and away from the first and second annular walls 604 605.

Typically, the cassette body 600 includes one or more gaskets or beads (a region of the cassette body providing an abutment surface) for sealing with an insert on contact. Providing a suitable gasket or bead can reduce the force required to create a fluid impermeable seal between the cassette body 600 and an insert during use.

Typically, the gasket or bead is provided as a continuous surface extending around the base of the cassette body 600 between the annular walls 604 605 and the outer wall 601.

Where a gasket is provided, typically the gasket is provided as a separate component that is arranged to be positioned in the base of the cassette body 600 adjacent to the annular walls 604 605. The gasket can be composed of a thermoplastic elastomer (TPE) material. The gasket can be manufactured using a suitable additive manufacturing process.

It will be understood that in certain embodiments, a gasket or bead is not provided and the seal between the cassette body 600 and an insert is provided by other means such as the contact between the components.

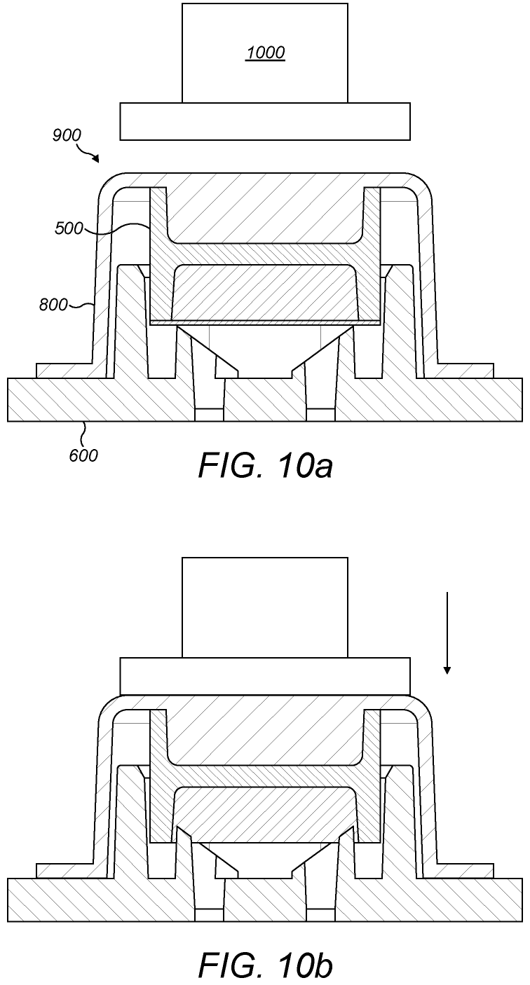

FIG. 7 is a diagram showing a portion of a microfluidic cassette according to an embodiment of the invention. In this embodiment, the cassette body includes first, second and third cassette insert arrangements 700 701 702 of the type described with reference to FIGS. 6a and 6b.

FIG. 8 is a diagram showing a cover element in accordance with an embodiment of the invention.

The cover element 800 is arranged to be secured via a fluid impermeable seal to form part of a microfluidic cassette body. The cover element 800 is typically sealed at an end portion 801 to provide an inner chamber 802. The cover element 800 is shaped so that it can enclose a region of the cassette body and an insert.

The cover element 800 is resiliently deformable. Typically, the cover element 800 is composed of a deformable material such as a thermoplastic elastomer.

The cover element 800 is arranged so that an insert can be secured to an inside surface of the cover element 800. In this embodiment, the cover element 800 includes a region 803 that is shaped to correspond with the shape of part of an insert to provide a friction fit between the cover element 800 and the insert.

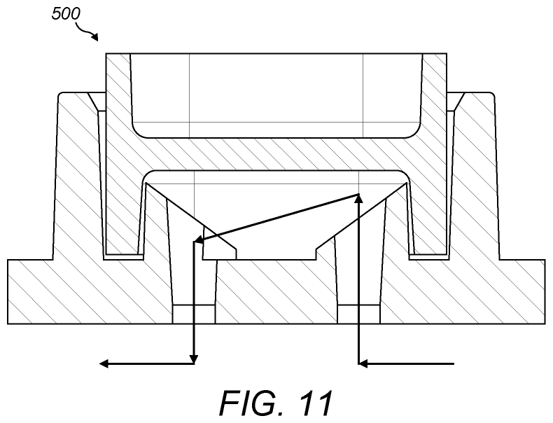

FIG. 9 is a diagram showing a cross sectional view of an assembled cassette insert arrangement 900 which includes the insert 500, cassette body 600 and cover element 800 described with reference to FIGS. 5, 6a-6b and 8 respectively.

The insert 500 has been secured to the inside surface of the cover element 800 and the cover element 800 has been sealed to the remainder of the cassette body 600. For clarity, the insert 500 is shown without any reagent in the chamber and without the chamber having been sealed.

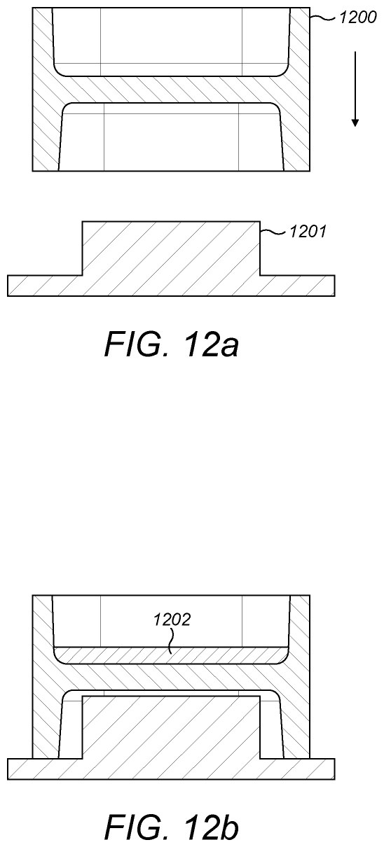

The cassette insert arrangement 900 will now be described in use with reference to FIGS. 10a to 10d.

The cassette insert arrangement 900 is initially in a ready to use configuration after the cassette has been inserted into a microfluidic diagnostic device. This is shown in FIG. 10a.

A moveable actuating member 1000 that is part of a microfluidic diagnostic device is also shown in FIG. 10a. The insert 500, which is secured to the inside surface of the cover element 800, is initially in a first position in which it is not in contact with the annular walls and before the seal has been broken.

Next, the moveable actuating member 1000 is moved towards the cover element 800. The actuating member 1000 makes contact with and begins to displace the cover element 800 and insert 500 towards the cassette body 600. This is shown in FIG. 10b. The direction of movement of the cover element 800 and insert 500 towards the cassette body 600 is guided by the outer wall of the cassette body 600 making contact with the insert 500.

The actuating member 1000 continues to displace the cover element 800 and insert 500 towards the cassette body 600. As the insert 500 is moved into the second position, which is shown in FIG. 10c, the annular walls of the cassette body 600 make contact with and pierce the seal of the insert 500. In this configuration, the insert 500 is sealed against the cassette body 600 and the insert chamber is in fluid communication with a microfluidic channel via the fluid apertures of the cassette body 600.

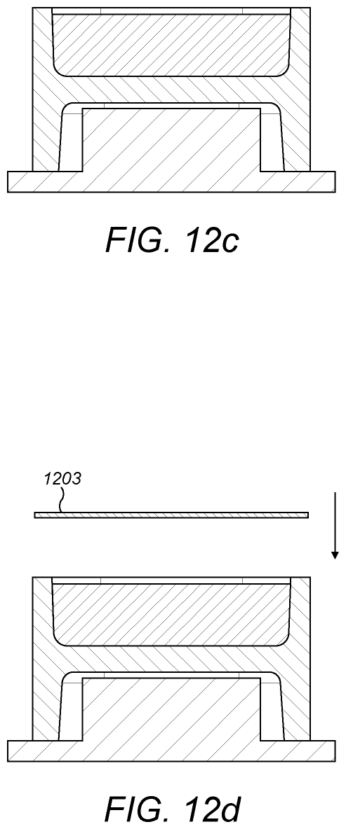

In this configuration, microfluidic tests can be performed by the microfluidic diagnostic device in which fluid flows through the insert 500 and interacts with reagent contained therein. FIG. 11 provides a simplified diagram showing the typical direction of fluid flow through the insert 500 during a microfluidic test.

After processing, the actuating member 1000 typically moves away from the cassette body 600, as shown in FIG. 10d. Due to the resilience of the cover element 800, this typically causes the cover element 800 to return to its original shape, thereby also moving the insert 500 away from the cassette body 600.

Due to the fluid impermeable seal between the cover element 800 and the cassette body 600, the cassette remains sealed throughout and fluid is prevented from leaking out of the inside of the cassette.

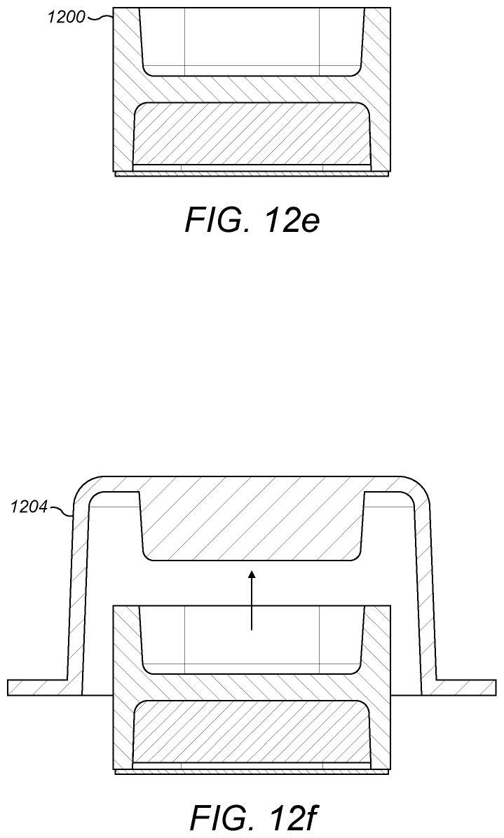

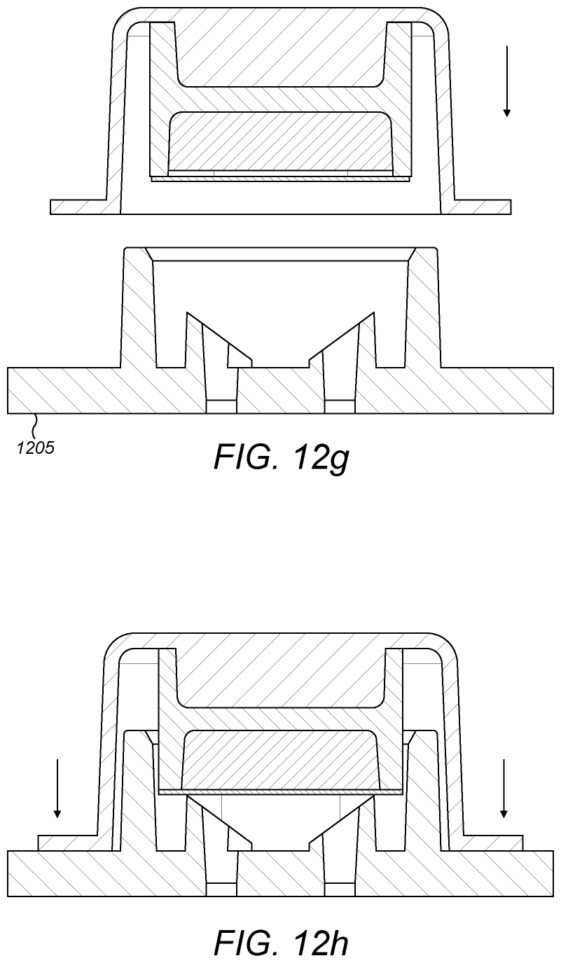

A method of manufacturing a plurality of sealed inserts will now be described with reference to FIGS. 12a to 12d. The method can be used to manufacture inserts of the type described with reference to FIG. 5.

First, a plurality of inserts are loaded onto a carrier structure. The carrier structure can be, for example, a 96-well plate, as known in the art. FIG. 12a shows a single insert 1200 as it is loaded onto a portion 1201 of a carrier structure.

Next, as shown in FIG. 12b, reagent 1202 is provided into a chamber region of the insert 1200. In this example, the reagent 1202 is a wet reagent. However, dried reagent can also be used.

Next, as shown in FIG. 12c, the reagent 1202 is lyophilised.

Next, as shown in FIG. 12d, a seal 1203 is provided over the chamber of the insert 1200 to seal the reagent 1202 inside the chamber. The seal 1203 provides a fluid tight seal to prevent any moisture or contaminants from contacting the reagent 1202. The seal 1203 can be composed of a foil material suitable for piercing.

Advantageously, the inserts are shaped so that they can be accurately and conveniently located in pre-determined positions on the carrier structure for processing. This can improve the speed and ease with which the inserts can be filled and sealed. In this example, the inserts 1200 have two correspondingly shaped enclosed regions located at opposite sides, either of which can be used to locate the inserts on the carrier structure.

A method of providing a cassette insert arrangement on a microfluidic cassette will now be described with reference to FIGS. 12e-h. In this example, the insert 1200 is an insert that has been prepared via the method described with reference to FIGS. 12a-d.

A sealed insert 1200 is provided, as shown in FIG. 12e.

Next, the insert 1200 is secured to an inside surface of a cover element 1204, as shown in FIG. 12f. In this example, the insert 1200 and cover element 1204 include regions that are shaped to provide a friction fit.

Next, the cover element and insert are positioned over a portion of a microfluidic cassette body 1205, as shown in FIG. 12g.

The cover element 1204 is then secured to the cassette body 1205 to provide a fluid impermeable seal, as shown in FIG. 12h. Typically the cover element is secured via a heat staking process, although other suitable processes could be used.

In certain embodiments, the cover element can be transparent and/or the insert can be coloured. Advantageously, this can improve the ease with which the cassette insert arrangement can be assembled by providing a visual indication of its internal configuration.

All of the features disclosed in this specification (including any accompanying claims, abstract and drawings), and/or all of the steps of any method or process so disclosed, may be combined in any combination, except combinations where at least some of such features and/or steps are mutually exclusive. Each feature disclosed in this specification (including any accompanying claims, abstract and drawings) may be replaced by alternative features serving the same, equivalent or similar purpose, unless expressly stated otherwise. Thus, unless expressly stated otherwise, each feature disclosed is one example only of a generic series of equivalent or similar features. The invention is not restricted to the details of the foregoing embodiment(s). The invention extends to any novel one, or any novel combination, of the features disclosed in this specification (including any accompanying claims, abstract and drawings), or to any novel one, or any novel combination, of the steps of any method or process so disclosed.

With respect to the use of substantially any plural and/or singular terms herein, those having skill in the art can translate from the plural to the singular and/or from the singular to the plural as is appropriate to the context and/or application. The various singular/plural permutations may be expressly set forth herein for sake of clarity.

It will be understood by those within the art that, in general, terms used herein, and especially in the appended claims are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (e.g., “a” and/or “an” should be interpreted to mean “at least one” or “one or more”); the same holds true for the use of definite articles used to introduce claim recitations. In addition, even if a specific number of an introduced claim recitation is explicitly recited, those skilled in the art will recognize that such recitation should be interpreted to mean at least the recited number (e.g., the bare recitation of “two recitations,” without other modifiers, means at least two recitations, or two or more recitations).

It will be appreciated that various embodiments of the present disclosure have been described herein for purposes of illustration, and that various modifications may be made without departing from the scope of the present disclosure. Accordingly, the various embodiments disclosed herein are not intended to be limiting, with the true scope being indicated by the following claims.

1. A microfluidic cassette comprising:
a microfluidic cassette body comprising at least one fluid flow channel, and
at least one chamber containing reagent, the chamber comprising a seal to prevent fluid from entering the chamber, wherein the seal is breakable in situ in the cassette body, and wherein the cassette body and the chamber are configured such that when the seal is broken, the reagent is exposed to fluid flow in the channel.

2. The microfluidic cassette of claim 1, further comprising a sealing layer on a surface of the cassette body adjacent to the at least one chamber to prevent fluid outside the microfluidic cassette from contacting the cassette body.

3. The microfluidic cassette of claim 1 or 2, further comprising an insert, wherein the insert comprises the at least one chamber.

4. The microfluidic cassette of claim 3, wherein the seal is breakable in situ when a piercing force is applied to the seal.

5. The microfluidic cassette of claim 4, wherein the cassette body comprises one or more seal breaking mechanisms adapted to break the seal.

6. The microfluidic cassette of claim 5, wherein the one or more seal breaking mechanisms comprise one or more structures adapted to pierce the seal in situ in the cassette body, and wherein the insert is secured within the cassette body and is movable from a first position within the cassette body where the seal is not in contact with the one or more structures to a second position within the cassette body where the seal is in contact with the one or more structures.

7. The microfluidic cassette of claim 6, wherein the one or more structures are adapted such that when the seal is pierced, a fluid flow channel through the chamber is formed, the fluid flow channel in fluid communication with the fluid flow channel of the cassette body.

8. The microfluidic cassette of claim 7, wherein the one or more structures comprises a first annular wall enclosing a first fluid aperture and a second annular wall enclosing a second fluid aperture, and wherein the first and second fluid apertures are in fluid communication with the fluid flow channel of the cassette body.

9. The microfluidic cassette of claim 8, wherein at least one of the annular walls includes a cut-out region around part of the circumference of the wall.

10. The microfluidic cassette of any of claims 6 to 9, wherein the cassette body further comprises a cover element arranged to provide a sealed chamber enclosing the one or more structures and the insert.

11. The microfluidic cassette of claim 10, wherein the insert is secured to an inner surface of the cover element.

12. The microfluidic cassette of claim 10 or 11, wherein the cover element is resiliently deformable.

13. The microfluidic cassette of claim 12, wherein the cover element is arranged to hold the insert in the first position and is resiliently deformable to move the insert into the second position.

14. The microfluidic cassette of claim 13, wherein the cassette body further comprises an outer wall enclosing the one or more structures, said outer wall shaped to guide movement of the insert between the first and second position.

15. The microfluidic cassette of any preceding claim, wherein the seal is breakable in situ when exposed to a temperature substantially above atmospheric temperature.

16. The microfluidic cassette of any preceding claim, wherein the seal is breakable in situ when exposed to a directional beam of light, and wherein the microfluidic cassette comprises at least one pathway that allows light to pass through the cassette and contact the seal.

17. A microfluidic diagnostic system comprising:
a microfluidic cassette according to any of claims 1 to 16; and
a microfluidic diagnostic device adapted to receive the microfluidic cassette, the device comprising:
one or more actuators adapted to break the seal of the microfluidic cassette.

18. The microfluidic diagnostic system of claim 17, wherein the one or more actuators comprise an aperture shaped to receive the microfluidic cassette body.

19. The microfluidic diagnostic system of claim 17 or 18, wherein the one or more actuators comprise a moveable actuating member.

20. The microfluidic diagnostic system of any of claims 17 to 19, wherein the one or more actuators comprise a source of heat.

21. The microfluidic diagnostic system of any of claims 17 to 20, wherein the one or more actuators comprise a source of directional light.

22. An insert for a microfluidic cassette body comprising:
at least one chamber containing reagent, the chamber comprising a seal to prevent fluid from entering the chamber, wherein the seal is breakable in situ in the cassette body.

23. A method of manufacturing a microfluidic cassette comprising:
providing a microfluidic cassette body comprising at least one fluid flow channel; and
providing at least one chamber containing reagent, the chamber comprising a seal to prevent fluid from entering the chamber, wherein the seal is breakable in situ in the cassette body, and wherein the cassette body and the chamber are configured such that when the seal is broken, the reagent is exposed to fluid flow in the channel.
